(19) United States
(12) Patent Application Publication
(10) Pub. No.: US 2018/0336507 A1
(43) Pub. Date: Nov. 22, 2018

(54) COGNITIVE RISK ANALYSIS SYSTEM FOR RISK IDENTIFICATION, MODELING AND ASSESSMENT

(71) Applicants: REPSOL, S. A., Madrid (ES); International Business Machines Corporation, Armonk, NY (US)

(72) Inventors: Ruben Rodriguez Torrado, New York, NY (US); Debarun Bhattacharjya, Yorktown Heights, NY (US); Jeffrey Owen Kephart, Yorktown Heights, NY (US); Jesus Maria Rios Aliaga, Yorktown Heights, NY (US); Dharmashankar Subramanian, Yorktown Heights, NY (US); Enara C. Vijil, Millwood, NY (US)

(73) Assignees: REPSOL, S. A., Madrid (ES); International Business Machines Corporation, Armonk, NY (US)

(21) Appl. No.: 15/962,213

(22) Filed: Apr. 25, 2018

Related U.S. Application Data
(60) Provisional application No. 62/509,526, filed on May 22, 2017.

(51) Int. Cl. G06Q 10/06; G06F 17/30

(52) U.S. Cl. CPC G06Q 10/0635; G06F 17/30979

(57) ABSTRACT

A risk modeling system, method and program product. A query orchestrator interfaces with users posing high-level queries and expanding high-level queries into lower level queries. A queryable risk extractor applies lower level queries to available risk-related knowledge to extract potential risks, e.g., to petrochemical resource production in a selected locale. A semantic enrichment unit applies semantic enrichment to extracted potential risks and selectively annotates the enriched results. A risk model builder generates a graphical risk model for display on a display. Risk analyst can use the graphical risk model to augment risk-related intelligence.

### CROSS REFERENCE TO RELATED APPLICATION

The present application claims benefit to provisional U.S. Application Ser. No. 62/509,526 (Attorney Docket No. YOR920161861US1), “COGNITIVE RISK ANALYSIS SYSTEM FOR RISK IDENTIFICATION, MODELING AND ASSESSMENT” to Ruben Rodriguez Torrado et al., filed May 22, 2017, assigned to the assignees of the present invention and incorporated herein by reference.

### BACKGROUND OF THE INVENTION

### Field of the Invention

The present invention is related to risk analysis, and more particularly to supplementing risk analysts to facilitate risk analysis without requiring the risk analysts to understand complex analytical methods.

### Background Description

Typical risk analysis for a business may involve internal risk analysts in concert with external risk advisory services and consultants (collectively risk analysts). The risk analysts identify risk threats that may be relevant to a specific situation, e.g., risks to petrochemical resource production in a selected locale. Economic systems are rife with heterogeneous risk threats and resulting events that can damage and disrupt businesses. Moreover, in the current age of globalization and interconnectedness businesses increasingly are exposed to new types of risks. An oil and gas company, for example, may be evaluating a new business opportunity, such as investing in an oil field development project in a country where the company has no prior experience. Beyond the inherent uncertainty in oil field geophysical properties, there are other inherent risks that may interfere with production. These inherent risks may include, for example, geopolitical conflicts, natural hazards, and nationalization of the energy industry.

The risk analysts must first identify any pertinent risks in a given opportunity. Next, the risk analysts use the identified risks to construct a model that models the opportunity as a generic stochastic process and quantifies the risk analysts' beliefs about, and the potential impacts of, those risks. Currently, constructing such a model is laborious and expensive. The risk analysts must use complex analytical methods to construct the model, even when the risks are well known and well understood. Unfortunately, risk analysts frequently are insufficiently familiar with the complex analytical methods used to model the opportunity as a generic stochastic process. This lack of the complex analytical skill makes a comprehensive risk analysis a daunting task. Further, new risk types make conducting a comprehensive and standardized risk analysis for any business opportunity even more challenging.

Thus, there is a need a simple and convenient way to assess risks in a business venture over a selected timeframe; and more particularly, for providing even analysts that are unfamiliar with complex analytical methods with flexibility and ease of assessment for assessing risks in oil field development that does not require risk analysis to stochastically model field production risks during the lifetime of the project.

### SUMMARY OF THE INVENTION

A feature of the invention is enhanced analyst productivity;

[symbol]

Another feature of the invention is that analysts unfamiliar with complex analytical methods flexibility can more easily assess risks without stochastically modelling the venture;

[symbol]

Yet another feature of the invention is human risk-related intelligence is augmented by systematically acquired risk-related knowledge, risk-related information is semantically enriched.

The present invention relates to a risk modeling system, method and program product. A query orchestrator interfaces with users posing high-level queries and expanding high-level queries into lower level queries. A queryable risk extractor applies lower level queries to available risk-related knowledge to extract potential risks, e.g., to petrochemical resource production in a selected locale. A semantic enrichment unit applies semantic enrichment to extracted potential risks and selectively annotates the enriched results. A risk model builder generates a graphical risk model for display on a display. Risk analyst can use the graphical risk model to augment risk-related intelligence.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a cognitive system for augmenting human risk-related intelligence for improving risk modeling and analysis effort productivity, according to a preferred embodiment of the present invention;

FIG. 2 shows a general example of a 3-layer risk model with risk event nodes identified in a high-level query for modeling the risk events over potentially long time horizons;

FIGS. 3A-B show a basic example a simple risk high-level model, i.e., a civil war, and a corresponding expanded civil war risk model, as expanded by a preferred cognitive system;

FIG. 4 shows an example of a preferred query orchestrator for interfacing with users, receiving several types of very general high-level risk-related queries from the users;

FIG. 5 shows an example of the preferred risk extractor using the risk taxonomy and corresponding textual description in learning and acquiring risk-related knowledge from the textual data corpus to gain conceptual understanding about various risks;

FIG. 6 shows an example of risk extraction by the risk extractor;

FIG. 7 shows an example of enriching risk information semantics from the risk information document corpus by the semantic enrichment unit;

FIG. 8 shows an example of the risk model builder modeling and analyzing risks.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

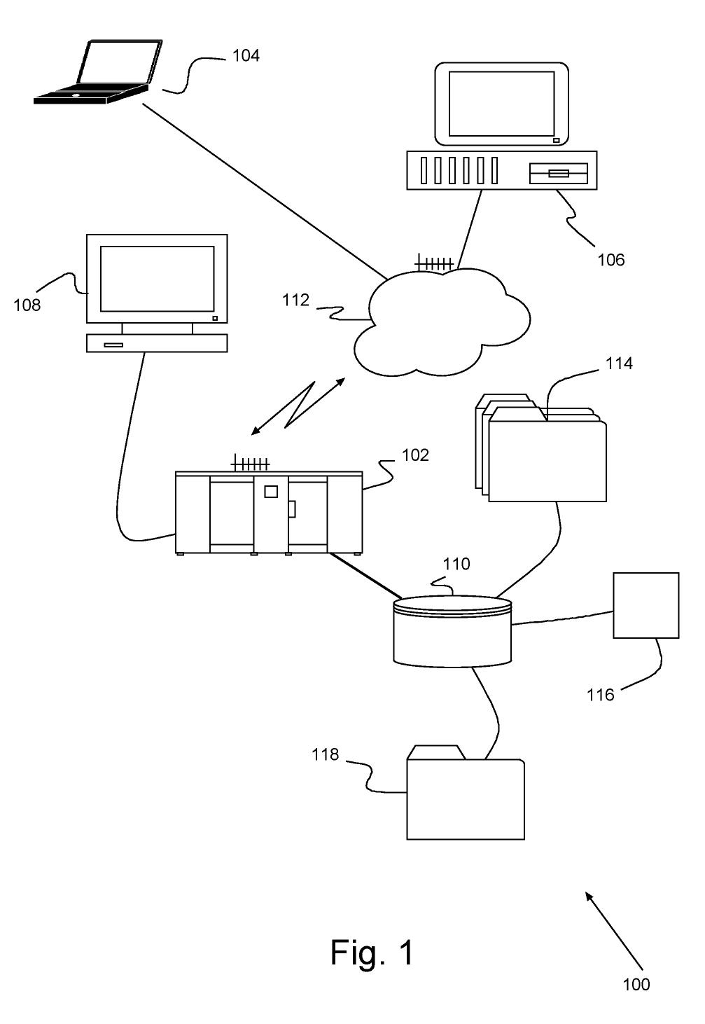

Turning now to the drawings and more particularly, FIG. 1 shows an example of a cognitive system 100 that augments human risk-related intelligence to improve risk modeling and reduce analysis effort for better productivity, according to a preferred embodiment of the present invention. The preferred cognitive system 100 may be embodied in one or more (three in this example) computers 102, 104, 106, 108 with risk-related knowledge stored, e.g., in local storage 110, all networked together on wired or wireless network 112. The risk-related knowledge in risk store 110 may include, for example, a comprehensive, defined risk taxonomy 114, semantic or textual descriptions 116 and an extensive textual data corpus 118.

A query orchestrator, e.g., computer 102, interfaces with the business user, e.g., a risk analyst, posing high-level queries. The high-level queries ($q$) may include, for example, providing a country name. The query orchestrator 102 expands the high-level queries to lower level queries. A queryable risk extractor, e.g., computer 104, uses the lower level queries to exploit the stored risk-related knowledge from risk store 110 to extract potential risks.

A semantic enrichment unit, e.g., computer 106, applies semantic enrichment to the results, annotating where appropriate. The semantic enrichment unit 106 indexes the risk data corpus and stores the enriched results in the risk-related knowledge in risk store 110 for flexibility in subsequent query and retrieval.

The risk model builder, e.g., computer 108, generates a three layer (3-layer) graphical risk model, for example, a dynamic nodal model of risk events restricted with 3 types of linked nodes. For example, the risk model builder may construct a dynamic nodal model of risk events, restricted to three (3) types of linked nodes, e.g., location-based (“Type 1”), risk type (“Type 2”) and conditional (“Type 3”). Thus, a Type 1 query may have the form $q=l$, where $l$ is a location. More specifically a Type 1 query may specify a country in the set $C$ that includes a neighboring set $\mathcal{N}_l$. A Type 2 query may include risk type ($r$∈$R$), e.g., $q=(l,r)$. A Type 3 query may further include a user-desired soft logical condition ($K$), e.g., $q=(l,r,K)$. It should be noted that these three query types are intended for example only and not intended as a limitation as many other query types may occur to a skilled artisan.

Using a location-based query a risk analyst can gain insight into various relevant risk events by querying the risk store 110. A risk analyst can read the contents of documents produced from the query for assessing model parameters

Preferably, the risk store 110 is a semantic document store that houses a representation of all documents in a corpus and also serves as an engine supporting auto-generated complex queries. The risk taxonomy 114 is a set of comprehensive risk classifications. Each risk classification has a corresponding textual description 116.

YAGO (Yet Another Great Ontology) and DBpedia are examples of suitable state of the art knowledge databases for knowledge and semantic extraction. Using a combination of natural language processing with automated ontologies on these textual sources enables a wide range of extractions. These techniques may be used to extract everything from shallow keywords to higher level concepts, named entities, relationships, sentiment, topics, and taxonomical classifications.

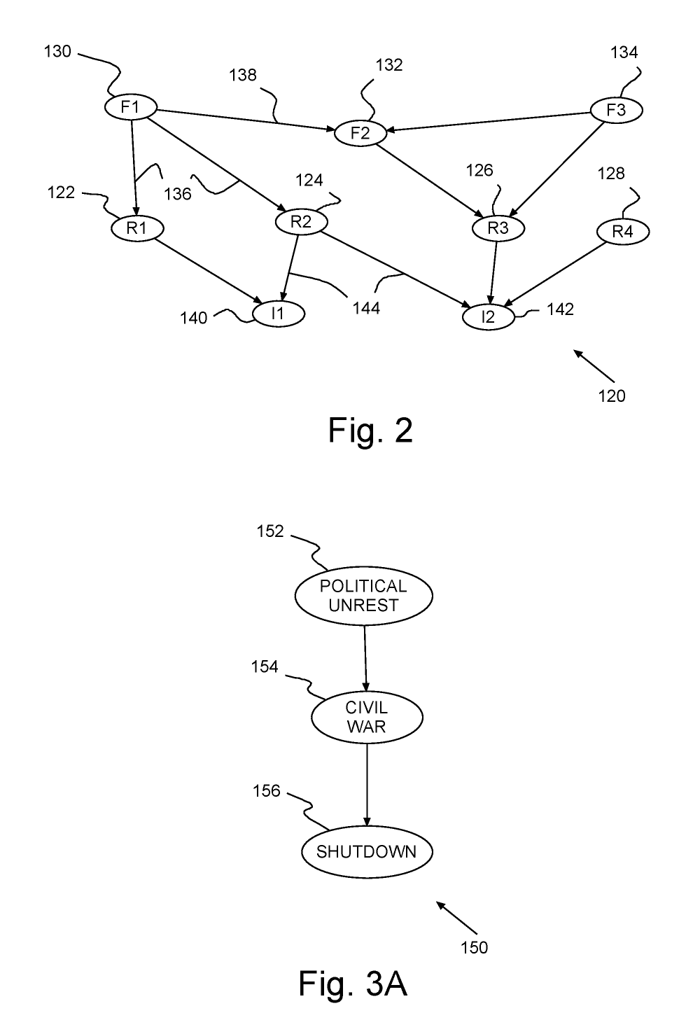

FIG. 2 shows a general example of a 3-layer risk model 120 with risk event nodes 122, 124, 126, 128 and a variety of risk factors 130, 132, 134. Each risk event nodes 122, 124, 126, 128 may be identified in a high-level query for modeling the risk events over potentially long time horizons. The risk factor nodes 130, 132, 134 have a set of discrete states, each of which has an associated probability and may be associated with each risk node 122, 124, 126, 128, directly 136 or indirectly 138. Each risk 122, 124, 126, 128 has potential impacts 140, 142 identified by links 144.

This three-layer model 120 provides a simple and convenient way for the risk analysts to assess beliefs about risk events over time. Further, risk analysts can use the model 120 to easily assess risks by sacrificing some flexibility to capturing complex stochastic processes, providing a simple graphical representation to augment human risk-related intelligence. Risk analysts can systematically acquire risk-related knowledge and semantically enrich the risk-related information while simultaneously, supplementing queryable risk documents in risk store 110 for future risk analysis.

Each discrete, risk event node 122, 124, 126, 128 may be expanded to super-nodes (not shown in this example), effectively representing vector-valued variables associated with specific properties. In a preferred model, the risk event nodes 122, 124, 126, 128 are associated with a type super-node, and are typed either single-event or recurring for the time period of interest.

Single-event risks may be associated with a start time (onset) node, the time at which the risk might occur, and an event duration (duration) node. Recurring risks may be associated with an event occurrence frequency (frequency) node, and an occurrence duration (duration) node. Each risk event node 122, 124, 126, 128 is conditioned on a probability of the states of parent risk factor nodes 130, 132, 134. Thus, onset/frequency and duration may be conditioned on the event type, and optionally represented as a continuous distribution. It should be noted that a (none) state may model the no risk events state. Impacts from the events are represented as nodes 140, 142 each impact may have a duration or be continuous. Impacts include, for example, monetary compensation or fines, partial or complete shutdown of facilities, and loss of life.

The risk factors 130, 132, 134 may include, for example, a temporal aggregation of underlying latent variables, an unobserved condition or event during the period of interest, and/or an unobserved condition or event at any particular epoch in time. Temporal aggregation might reflect inequality indices of a country aggregated over time. An unobserved condition or event might be, for example, a determination of whether an economic indicator passes a threshold. An example of an unobserved condition or event might be the election of a particular candidate at a scheduled election.

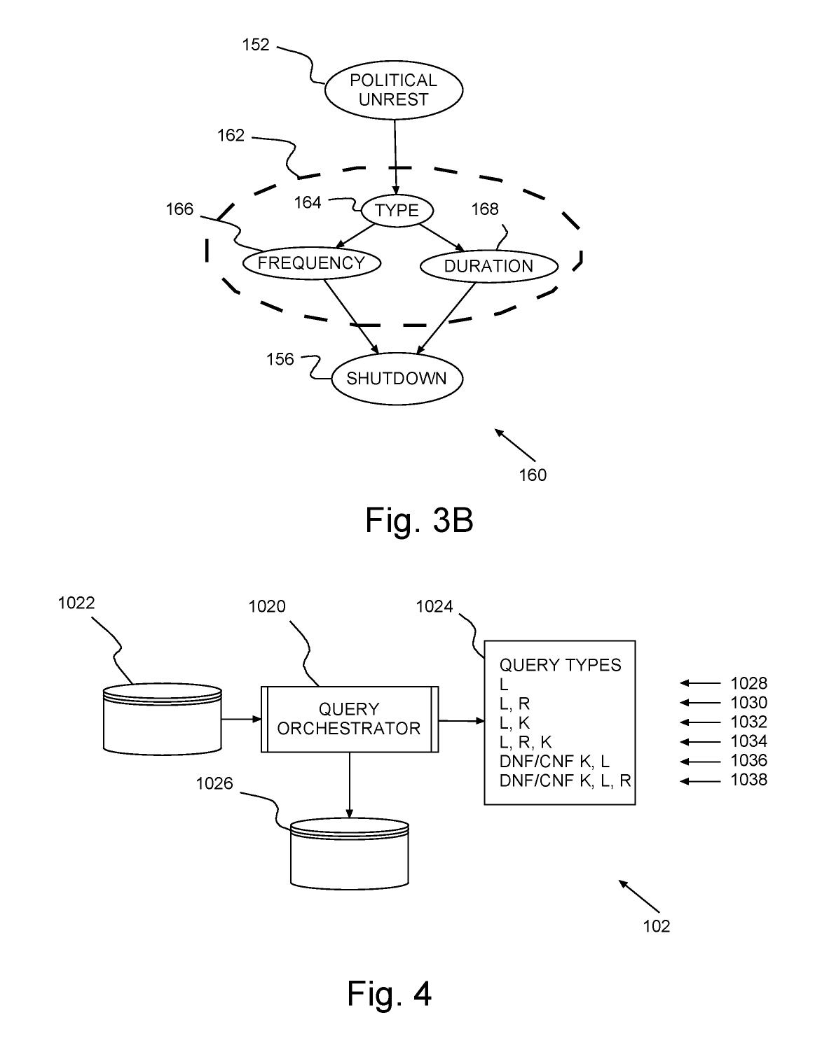

FIGS. 3A-B show a basic example a simple risk high-level model 150, a civil war in this example, and a corresponding expanded risk model 160, as expanded by a preferred cognitive system, e.g., 100 of FIG. 1. Specified parameters are represented as risk factor nodes 152 for the risk event node 154 or super (risk event) nodes 162 with impact node 156. An analyst defines a discrete set of states for each risk factor node 152, and assesses a marginal probability for each state. The analyst also defines a discrete set of states for the type of each risk event node 154, and assesses appropriate conditional probabilities. The analyst also assess the impact 156 of risk events over the event duration. Thus, the expanded civil war risk model 160 assists the analyst in defining risk model structure and parameters.

So, for this example, the analyst might define two political unrest states 152 low and high, and assess corresponding probabilities $0.75$ and $0.25$, respectively. The analyst may also define civil war 162 type states 164 as major and minor, and assess conditional probabilities conditioned on the political unrest states 152. So, if political unrest is high the conditional probability of major is 0.8, and otherwise the conditional probability of minor is 0.2. On the other hand, if political unrest is low, the conditional probability of major is 0.1, while the conditional probability of minor is 0.9.

Moreover, the analyst may characterize the risk event frequency 166 and duration 168, conditioned upon the type 164. For example, the analyst may assess the frequency of events characterized by a Poisson distribution with a rate conditioned on type 164, e.g., if the type is minor the rate is $0.01$ per year; and otherwise the type 164 is major and the rate is $0.1$ per year. Similarly, the analyst may determine that upon the occurrence of an event, independent of type 164, whether major or minor, the event is likely to have a duration 168 uniformly distributed over a range, e.g., from $1$ to $3$ years.

Finally, the analyst assesses the impact 156 of risk events 162 over the duration 168. For example, facilities may be completely shut down when the civil war risk event is active and otherwise 100% operational. Alternatively, for the duration of the civil war facility operation may range between 0% and 50%, with a degree of closure generated for a uniform distribution. The resulting expanded risk model 160 highlights where the analyst may wish to access the risk store through various types of risk-related queries.

The taxonomy 114 and descriptions 116 provide a baseline understanding for communicating in identifying, measuring, deciding, treating, monitoring and otherwise discussing risk. An example of such a taxonomy is provided by Coburn, et al., “A Taxonomy of Threats for Complex Risk Management, Cambridge Risk Framework series;” Centre for Risk Studies, University of Cambridge (June, 2014). The Coburn, et al. taxonomy enumerates twelve risk categories. Eleven of the categories are specific risk categories that include: financial shocks, trade disputes, geopolitical conflicts, political violence, natural catastrophes, climatic catastrophes, environmental catastrophe, technological catastrophes, disease outbreaks, humanitarian crises and externalities. These eleven specific risk categories are supplemented by a twelfth, societal effects, and a miscellaneous or catch all risk category, i.e., other shocks.

Financial shocks include financial system events that cause short-run fluctuations and/or significant changes in long-run economic growth. Trade disputes include events that cause widespread changes or disruption to international trading conditions. Geopolitical conflicts include military engagements and diplomatic crises between nations with global implications. Political violence includes acts or threats of violence by individuals or groups for political ends. Natural catastrophes include naturally occurring phenomena that cause widespread disruption. Climatic catastrophes include climatic anomalies that cause extreme and unusual weather conditions. Environmental catastrophes include crises that lead to significant and widespread change to environmental or ecological equilibriums. Technological catastrophes include accidental or deliberate industrial events affecting local and global Stakeholders. Disease outbreaks affect humans, animals and/or plants. Humanitarian crises reflect the impact of conditions on mass populations. Externalities include extra-terrestrial threats, e.g., from astronomical objects and space weather. Societal effects include events such as social protest, activism, bribery and corruption, and crime and lawlessness in society.

The textual data corpus 118 includes risk-related data and is predominantly an unstructured collection or aggregation of current and historical information regarding various risk occurrences in different parts of the world. Typical such risk-related data is available for collection over the Internet, for example, from traditional web-based sources and social media. These sources may include, for example, archived and streaming news articles, blogs, web feed formats (e.g., RSS), Facebook and Twitter.

GeoNames (www.geonames.org), is an example of a suitable web-based database with world location names, and over eight million records spanning 253 countries. The GeoNames database contains locations at various resolutions, such as country, city and street along with latitude and longitude information. The GeoNames database also includes various other useful statistics, e.g., population and area.

An example of the static corpus of English news articles, currently the largest available, is Parker, et al., English Gigaword Fifth Edition LDC2011T07. DVD. Philadelphia: Linguistic Data Consortium, 2011 (Gigaword). Gigaword currently includes about ten million articles from seven different news sources that collectively cover between 1994 and 2011. The preferred system 100 supplements Gigaword, for example, with more recent news that is current and dynamic, e.g., using AlchemyData News from International Business Machines Corporation (IBM). AlchemyData News is a cloud-based, software-as-a-service that daily indexes two hundred fifty to three hundred thousand (250K-300K) English language news and blog articles with a historical window that spans the past 60 days of data ingestion time stamps. Further, URLs of news articles are extracted from EventRegistry (eventregistry.org). EventRegistry is cloud-based, software-as-a-service and a dynamic source of articles span, approximately, the past 12 to 24 months.

Taken together, the collective source of news articles from Gigaword, AlchemyData News and EventRegistry may form an example of a risk information document corpus 118. Such a document corpus 118 provides an extensive set of current and historical realizations of the various risks and related events for assisting risk analysis in a given context. This collective source spans a sufficiently long time frame for acquiring risk-related information and related instances, and for semantic enrichment of each document in the document corpus 118.

Further, knowledge extraction may be applied with machine learning to unstructured sources such as social media and streaming news in surveillance to detect relevant events or determine alert issuance. In addition to probabilistic models and scenario analysis approaches, Elasticsearch (www.elastic.co/products/elasticsearch) is a state of the art tool for distributed and efficiently searching a previously annotated and enriched, large textual data corpus. REST (REpresentational State Transfer) application program interface (API) may be used to interface to the web. REST is described in a University of California, Irvine, doctoral dissertation by Roy Fielding (www.ics.uci.edu/˜fielding/pubs/dissertation/rest_arch_style.htm).

Thus, the preferred cognitive system 100 allows many variations and combinations of risk analysis queries. The responses to those queries may provide the analyst with sufficient contextual and relevant background information. This information may facilitate identifying relevant risks for further model based quantification and assessment.

FIG. 4 shows an example of a preferred query orchestrator (102 in FIG. 1) for interfacing with users, receiving several types of very general high-level risk-related queries from the users. The query orchestrator 102 uses a suitable search engine 1020, preferably Elasticsearch, to automatically translate high level queries to low-level queries, e.g., Query Domain Specific Language (DSL) required by ElasticSearch. The suitable search engine 1020 uses the low-level queries to search the document store 1022, returning the search results 1024 with contextually relevant rankings. Elasticsearch includes a flexible, expressive search language, Query DSL, that the query orchestrator 102 uses on other knowledge databases 1026, such as GeoNames, for query-expansion to fully exploit the semantically enriched documents in risk store 110.

The resulting queries may be 1024 typed as Location 1028, Location & Risk 1030, Location & Keywords 1032, Location, Risk, Keywords 1034, disjunctive normal forms (DNFs) and/or conjunctive normal forms (CNFs) logical combinations of Keywords, with Location 1036, and DNF/CNF logical combinations of Keywords, with Location and Risk 1038.

Elasticsearch is a Java based search engine on Lucene for distributed, multitenant-capable full-text searching. Query orchestrator 102 constructs a JavaScript Object Notation (JSON) object for each document in the corpus. Each JSON object is endowed with a key-value pair corresponding to each of the elements in the final representation as described hereinbelow. These JSON objects are suitable for semantic extraction using natural language processing, e.g., AlchemyAPI. Further, Elasticsearch provides very flexible querying with programmatic APIs for automatically generating complex queries that correspond to the simpler, lower-level queries.

The GeoNames database 1026 provides for acquiring knowledge about various countries and their regional bordering neighbors. The system 100 acquires and represents knowledge from the GeoNames database 1026 as a full set of 253 countries and corresponding sets of neighboring countries for geographically expanding the high level queries.

So in the above query examples, an analyst may need to examine historically how risk with regard to a country and neighborhood may motivate the first-type ($q=l$) query. The query orchestrator 102 expands the query to consider the region in which $l$ is located, by virtue of neighboring set ${N}_l$. Simultaneously, the risk extractor 104 and the semantic enrichment unit 106 automatically convert a tuned Elasticsearch query variation into a JSON-like query in Query DSL syntax. Using REST API the system 100 stores the auto-generated query to the risk store 110 for subsequently retrieving contextually relevant documents. The risk model builder 108 returns a summary of retrieved documents, organized by risk type and by country. Preferably, the summary also includes links enabling an analyst to explore extensively the raw textual content in each of the matching documents.

For the above Type 2 example, the analyst may need to examine the relevant textual content in documents for a specific risk type with regard to a country and neighborhood ($q=(l,r)$), e.g., the risk may be of a comprehensive documented trade dispute in Bolivia. The query orchestrator 102, risk extractor 104 and semantic enrichment unit 106 may auto-generate the corresponding Query DSL query, which the system 100 stores in risk store 110. The risk model builder 108 also returns a list of documents from the risk store 110 that meet the query conditions. Preferably, the listed documents are sorted in the decreasing order of contextual relevance score. The list is monotonic with agreement between input query conditions and the fields present in each document. Elasticsearch determines a contextual relevance score while generating a response to the auto-generated Query DSL query.

For the above third Type 3 example, where the analyst may need to examine the relevant articles or documents that are contextually relevant to the chosen country and risk-type, and further, in agreement with a specific condition ($q=(l,r,K)$). In this example a soft condition modifies the set of documents, giving highest priority to those that satisfy the soft condition. The conditions may be specified as disjunctive or conjunctive normal forms over any number of user selectable keywords or phrases. The risk model builder 108 uses the full-textual search capability of Elasticsearch over the content field to evaluate the conditions. For example, the analyst may give highest priority to articles relevant to trade disputes and Bolivia that mention “Government profitability.” Again, the risk model builder 108 returns a list of documents in the risk store 110 that meet the query conditions with priority to those that meet the soft condition. Preferably, the listed documents are sorted in the decreasing order of an over contextual relevance score with articles satisfying the soft condition having higher scores than those partially satisfying it, or not satisfying it.

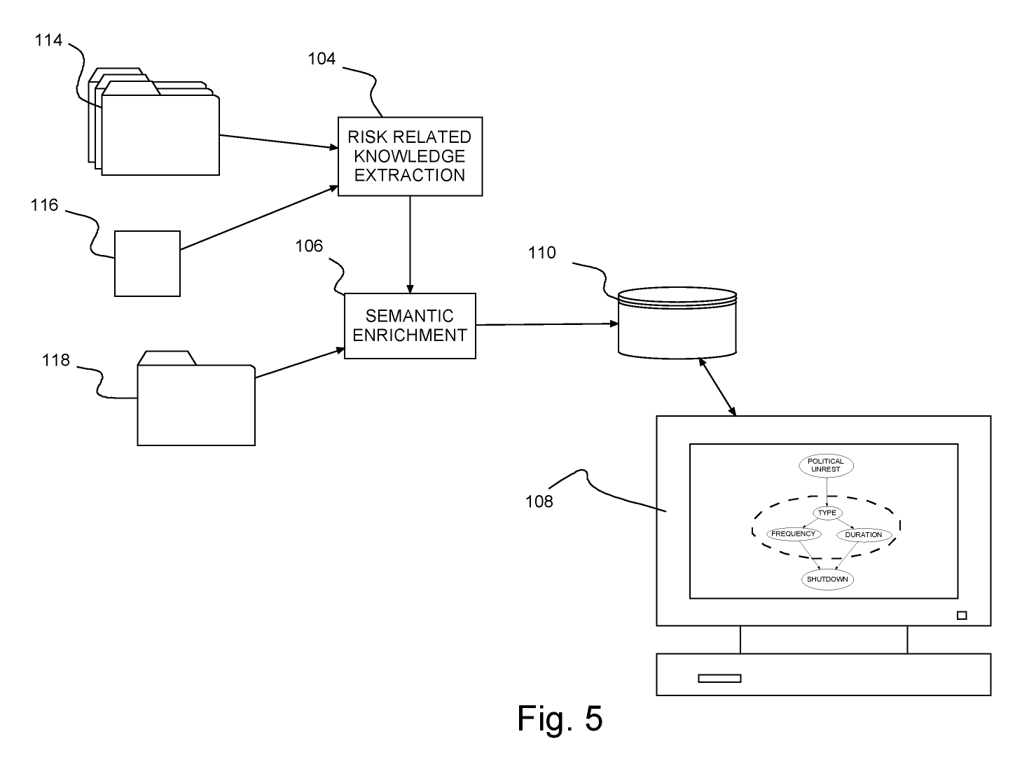

FIG. 5 shows an example of the preferred risk extractor 104 using the risk taxonomy 114 and corresponding textual description 116 in learning and acquiring risk-related knowledge from the textual data corpus 118 to gain conceptual understanding about various risks. The risk extractor 104 extracts semantic knowledge (risk-related facts) about various risk events and related descriptions from the textual data corpus 118. The risk extractor 104 may apply suitable semantic knowledge extraction technique to learn and acquire risk-related knowledge from unstructured sources. Suitable semantic knowledge extraction techniques, may include as, for example, advanced natural language processing and/or machine learning. The cognitive system 100 applies semantic enrichment 106 to the risk information corpus 118 to annotate and index the risk data and stores the results in risk store 110 for subsequent query and retrieval, and modeling by the risk modeler 108, e.g., for a risk analyst.

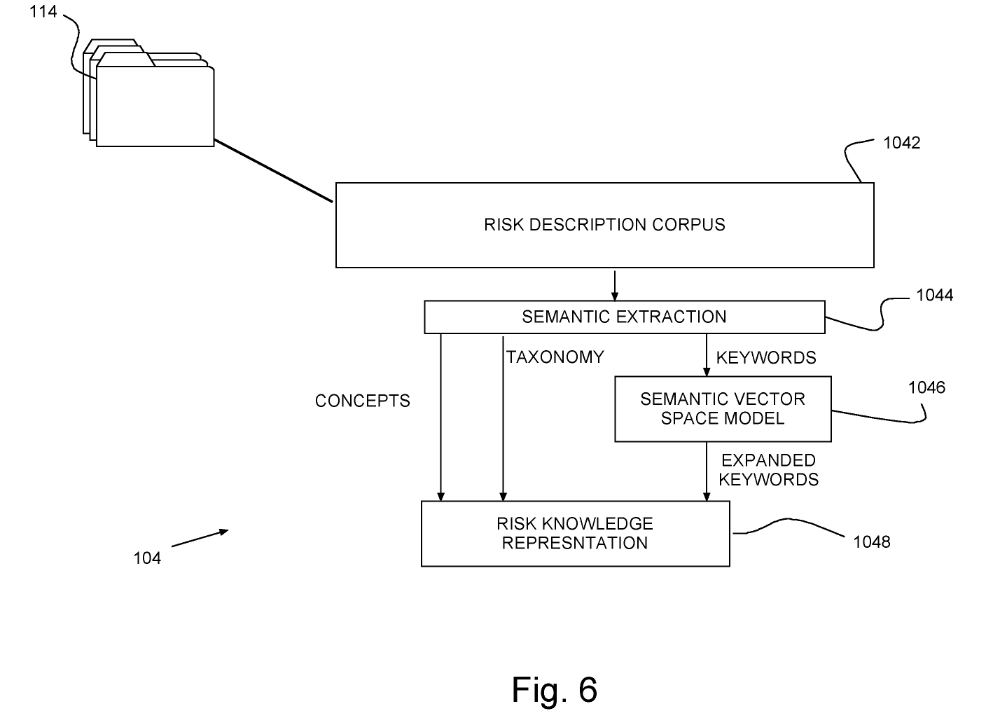

FIG. 6 shows an example of risk extraction 1040 by the risk extractor 104 of FIGS. 1 and 5 with like features labeled identically. The risk description corpus (∀r∈R) 1042 includes textual content that contextually describes risk. For examples of suitable risk description corpora 1042, see, e.g., cambridgeriskframework.com/threatclass/1 and cambridgeriskframework.com/threatclass/2. A semantic extractor 1044 extracts risk related concepts (Cᵣ), taxonomy (Tᵣ) 114 and keywords (\tilde{K}ᵣ) from the risk description corpus 1042. Preferably, the semantic extractor 1044 is a suitable machine learning (specifically, deep learning) unit providing natural language processing, for example, AlchemyAPI. A semantic vector space model 1046, e.g., Glove, provides expanded keywords (Kᵣ) that combine with the concepts and taxonomy in a risk knowledge representation ({Kᵣ,Cᵣ,Tᵣ}, ∀ᵣ∈R) 1048 to assist in risk identification, modeling and assessment. An example of a suitable semantic vector space model 1046 is provided by Pennington et al. “GloVe: Global Vectors for Word Representation,” Proceedings of the 2014 Conference on Empirical Methods in Natural Language Processing, pages 1532-1543.

The comprehensive risk taxonomy 114 facilitates learning and acquiring risk-related knowledge and a conceptual understanding of the various risks for the cognitive risk analysis in identifying, collecting, and enriching relevant risk-related signals from unstructured media sources. The risk description corpus 1042 provides the preferred cognitive risk analysis system 100 with a necessary risk-specific knowledge base (i.e., an understanding of the various kinds of risks) for risk identification, modeling and/or assessment.

As noted hereinabove, the preferred risk taxonomy 114 includes augmented risk types with an added societal category for events such as social protest, activism, bribery and corruption, and crime and lawlessness in society. Thus, the preferred risk taxonomy 114 covers a nearly complete set of risks that businesses may care about for an instance-agnostic analysis. The risk taxonomy 114 facilitates acquiring a conceptual and descriptive level understanding of the various risk types from semantic knowledge extraction results using the semantic vector space model 1046 for word proximity identification.

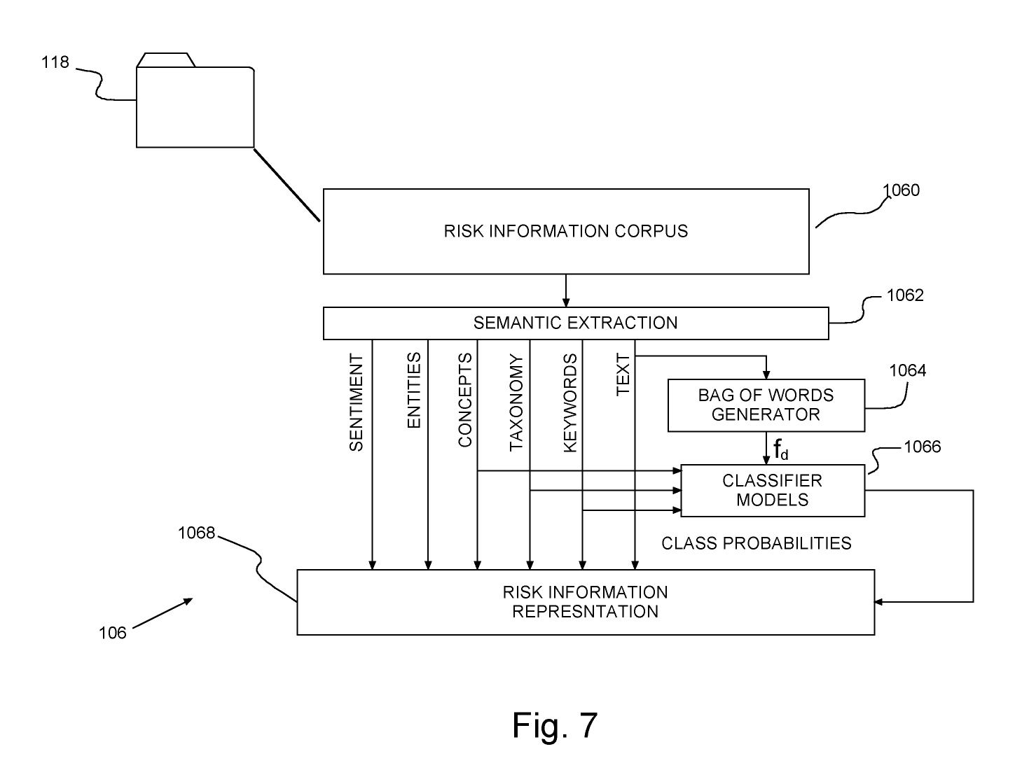

FIG. 7 shows an example of enriching risk information semantics 1060 from the risk information document corpus (d∈D) 118 by the semantic enrichment unit 106 of FIGS. 1 and 5 with like features labeled identically. A semantic extractor 1062 operates on the risk information corpus documents (∀d∈D) 118 to extract enrichment information. In this example, the enrichment information extracted from the documents includes sentiment (s_{d}), Entities (E_{d}), risk related concepts (C_{d}), taxonomy (T_{d}) 114, keywords (K_{d}) and text (t_{d}). Preferably, the semantic extractor 1062 is a suitable machine learning (specifically, deep learning) unit providing natural language processing such as, for example, AlchemyAPI. A bag of words generator 1064 deconstructs (f_{d}) the extracted text.

A model classifier 1066 generates models (Mᵣ,∀r∈R) from the taxonomy 114, keywords and text with class probabilities (P_{d,r},∀r∈R). The models combine with sentiment, Entities, risk related concepts, taxonomy 114, keywords and text in an enriched risk information representation ({K_{d},C_{d},T_{d},E_{d}(ρ_{e,d},s_{e,d}), ∀e∈E_{d},s_{d},t_{d},P_{d,r}∀r∈R}) 1068 for use by the risk model builder 108 in formulating a graphical model for each query and assesses required probabilities. Optionally, the risk analyst can express and formulate appropriate risk models to attempt risk quantification for consideration in business decision analysis.

The risk model builder 108 conducts a comprehensive internal search on the enriched lower level queries and applies well known data analysis techniques to extract textual signals from the unstructured data. From these textual signals the risk model builder 108 determines the relevance of the data to various risks and organizes and annotates the data to enable searches from contextually relevant queries. Thus, the resulting risk model exploits various relevant bits and pieces of risk-related knowledge and data in risk store 110. A particular family of models succinctly represents risk events as stochastic processes over a long time horizon.

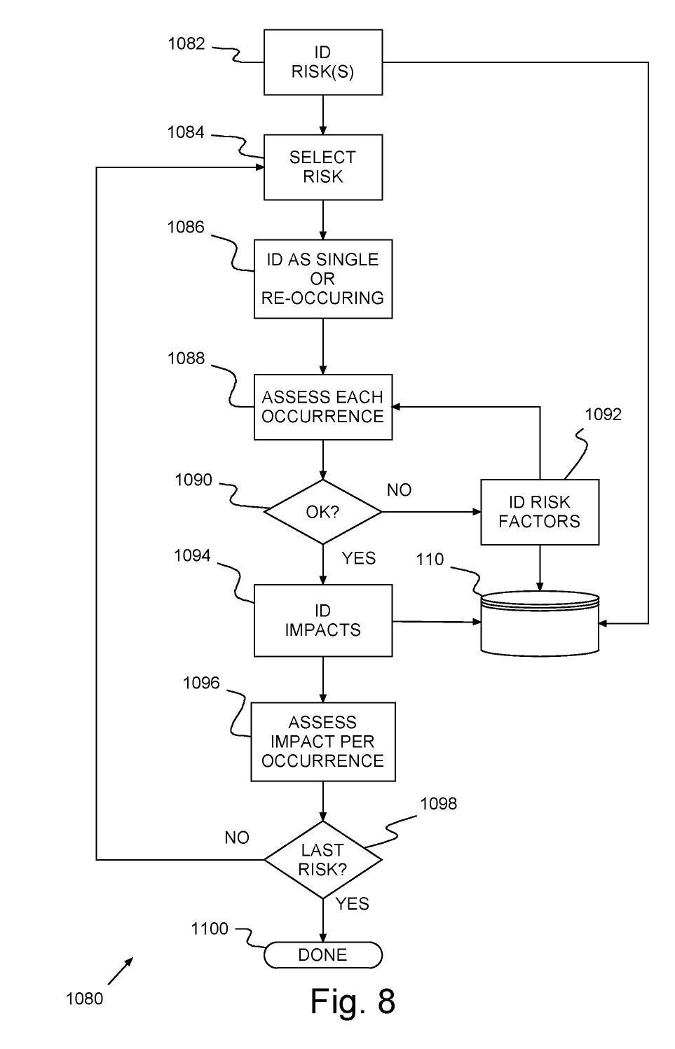

FIG. 8 shows an example of the risk model builder (108 of FIGS. 1 and 5) modeling risks for guiding a user in analyzing those risks 1080 according to a preferred embodiment of the present invention, e.g., using the preferred cognitive system 100 of FIG. 1 to model risk model 120 of FIG. 2 with like features labeled identically. The query orchestrator 102 identifies risks 122, 124, 126, 128 in a high-level query 1082 and stores those identified risks 122, 124, 126, 128 in risk store 110. After extracting 104 and enriching 106, the model builder 108 selects 1084 one of those risks, e.g., 124, and the user indicates 1086 whether the selected a risk is for a potentially recurring event. Then, the user indicates 1090 whether the assessment is satisfactory. If the assessment yielded 1090 unsatisfactory results so far, then the user identifies and additional potential risk factors 130, 132, 134 for further assessment 1092. After the risk model builder 108 stores 110 those risk factors 130, 132, 134, the model builder 108 again facilitates assessing 1088 the likelihood of occurrence.

When the user indicates the results 1090 are satisfactory, and identifies 1094 potential impact(s) 136, 138 the model builder 108 store 110 the results. Then the user can assess 1096 the potential impact(s) 136, 138 of the risk event occurrence. If the user indicates that any risks remain 1098 for assessment, then the user selects 1084 another risk, e.g., 126, and assessment continues until all risks 122, 124, 126, 128 have been assessed 1100.

Thus advantageously, the preferred cognitive system provides graphical models for non-technical, human risk analysts seeking to identify and analyze potentially pertinent risks to a given location, especially for oil field investment decisions in various parts of the world. The models augment human risk-related intelligence by systematically acquiring risk-related knowledge, semantically enriching the risk-related information, supplementing the queryable risk document store, and graphically modeling risk assessment formulations. The queryable risk document store provides a richly annotated trove of risk-related information from traditional sources as well as social media. Thus, the preferred cognitive system significantly improves risk modeling productivity and analysis efforts, and provides for many variations and combinations of risk analysis queries. The responses to those queries may provide the analyst with sufficient contextual and relevant background information to facilitate identifying relevant risks for further model based quantification and assessment.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A risk modeling system comprising:
a query orchestrator interfaces with users posing high-level queries and expanding said high-level queries into lower level queries;
a queryable risk extractor applying said lower level queries to available risk-related knowledge to extract potential risks;
a semantic enrichment unit applies semantic enrichment to extracted said potential risks and selectively annotating the enriched results;
a risk model builder generating a graphical risk model; and
a display displaying said graphical risk model, said graphical risk model augmenting human risk-related intelligence for the querying user.

2. A risk modeling system as in claim 1, further comprising a risk-related knowledge store wherein said queryable risk extractor applying said lower level queries to said risk-related knowledge store.

3. A risk modeling system as in claim 2, wherein said risk-related knowledge store includes a defined risk taxonomy, textual descriptions and a risk data corpus.

4. A risk modeling system as in claim 3, wherein
said semantic enrichment unit indexes said risk data corpus and stores the enriched results in said risk-related knowledge store, said enriched results improving flexibility in subsequent query and retrieval: and
said risks are risks to petrochemical resource production in a selected locale.

5. A risk modeling system as in claim 1, wherein said risk model builder generates a multilayer graphical risk model.

6. A risk modeling system as in claim 5, wherein said multilayer graphical risk model is a three layer (3-layer) dynamic nodal model of risk events restricted including three (3) types of linked nodes.

7. A risk modeling system as in claim 6, wherein the linked node types include a location-based type, risk type and a conditional type.

8. A method of modeling risk, said method comprising:
receiving high-level queries about potential risks to production in a selected locale;
expanding said high-level queries into lower level queries;
querying available risk-related knowledge with said lower level queries to extract said potential risks;
applying semantic enrichment to said potential risks;
generating a graphical risk model of enriched said potential risks; and
displaying said graphical risk model, said graphical risk model augmenting human risk-related intelligence for the querying user.

9. A method of modeling risk as in claim 8, wherein querying said risk-related knowledge includes querying a defined risk taxonomy, textual descriptions and a risk data corpus stored in a risk-related knowledge store.

10. A method of modeling risk as in claim 9, wherein
applying semantic enrichment includes indexing said risk data corpus and storing the enriched results in said risk-related knowledge store, said enriched results improving flexibility in subsequent queries: and
said potential risks are potential risks to petrochemical resource production in a selected locale over a selected timeframe.

11. A method of modeling risk as in claim 8, wherein applying semantic enrichment includes annotating the enriched results.

12. A method of modeling risk as in claim 8, wherein generating said graphical risk model comprises generating a multilayer dynamic nodal model of production risks.

13. A method of modeling risk as in claim 12, wherein generating a multilayer dynamic nodal model comprises generating a three layer (3-layer) dynamic nodal model of risk events restricted including three (3) types of linked nodes, said linked node types include a location-based type, risk type and a conditional type.

14. A method of modeling risk as in claim 8, wherein generating said multilayer dynamic nodal model comprises:
selecting a potential risk;
determining whether the selected risk may be a risk from a recurring event or a single event;
determining likelihood of occurrence of the event for said selected risk;
identifying potential impacts from said event;
assessing identified said potential impacts; and until all potential risks have been selected for assessment,
returning to selecting and selecting a next potential risk.

15. A method of modeling risk as in claim 14, wherein assessing identified said potential impacts further includes determining whether the assessment yields 1090 satisfactory results, and whenever the results are unsatisfactory:
identifying and assessing additional potential risk factors; and
returning to determining the likelihood of occurrence.

16. A computer program product for modeling production risks, said computer program product comprising a non-transitory computer usable medium having computer readable program code stored thereon, said computer readable program code causing one or more computers executing said code to:
receive high-level queries about potential risks to production in a selected locale;
expand said high-level queries into lower level queries;
query available risk-related knowledge with said lower level queries to extract said potential risks;
apply semantic enrichment to said potential risks and annotate the enriched results;
generate a graphical risk model of enriched said potential risks; and
display said graphical risk model, said graphical risk model augmenting human risk-related intelligence for the querying user.

17. A computer program product for modeling production risks as in claim 16, wherein
querying said risk-related knowledge causes said one or more computers executing said code to query a defined risk taxonomy, textual descriptions and a risk data corpus stored in a risk-related knowledge store;
applying semantic enrichment causes said one or more computers executing said code to index said risk data corpus and store the enriched results in said risk-related knowledge store, said enriched results improving flexibility in subsequent queries: and
said potential risks are potential risks to petrochemical resource production in a selected locale over a selected timeframe.

18. A computer program product for modeling production risks as in claim 16, wherein generating said graphical risk model causes said one or more computers executing said code to generate a multilayer dynamic nodal model of production risks.

19. A computer program product for modeling production risks as in claim 18, wherein generating a multilayer dynamic nodal model causes said one or more computers executing said code to generate a three layer (3-layer) dynamic nodal model of risk events restricted to including location-based type, risk type and a conditional type linked nodes.

20. A computer program product for modeling production risks as in claim 18, wherein generating said multilayer dynamic nodal model causes said one or more computers executing said code to:
Select a potential risk;
determine whether the selected risk may be a risk from a recurring event or a single event;
determine likelihood of occurrence of the event for said selected risk;
identify potential impacts from said event;
assess identified said potential impacts; and until all potential risks have been selected for assessment,
return to selecting and selecting a next potential risk.
